(19) United States
(12) Patent Application Publication
(10) Pub. No.: US 2016/0077578 A1
(43) Pub. Date: Mar. 17, 2016

(54) METHOD FOR CONTROLLING AN ELECTRONIC DEVICE WITH AID OF THERMAL DETECTION, AND ASSOCIATED APPARATUS AND ASSOCIATED COMPUTER PROGRAM PRODUCT

(71) Applicant: MEDIATEK INC., Hsin-Chu (TW)

(72) Inventor: Chi-Shiang Kuo, Taipei City (TW)

(21) Appl. No.: 14/484,298

(22) Filed: Sep. 12, 2014

(51) Int. Cl. G06F 1/32

(52) U.S. Cl. CPC G06F 1/3296

(57) ABSTRACT

A method for controlling an electronic device with aid of thermal detection, and an associated apparatus and an associated computer program product are provided, where the method includes the steps of: performing thermal detection for the electronic device, to generate at least one thermal detection result; and based on the at least one thermal detection result, selectively waking up the electronic device, not waking up the electronic device, controlling a screen of the electronic device to remain on, or turning off the screen of the electronic device. The apparatus includes: at least one thermal sensor capable of performing thermal detection for the electronic device, to generate the at least one thermal detection result; and a processing circuit, coupled to the at least one thermal sensor. The computer program product has program instructions for instructing a processing circuit of the electronic device to perform one or more operations of the method.

### BACKGROUND

The present invention relates to user control of an electronic device, and more particularly, to a method for controlling an electronic device with aid of thermal detection, and an associated apparatus and an associated computer program product.

According to the related art, in a situation where a conventional electronic device such as a multifunctional mobile phone is in a standby status, when a user wants to use the conventional electronic device, the user may need to push a physical button of the conventional electronic device, such as a Home button or a Power on/off button, in order to wake up the conventional electronic device. However, some problems may occur. For example, the user may be forced to push the physical button before using the conventional electronic device, causing the user to feel inconvenient. In another example, in a situation where this physical button such as the Power on/off button is positioned at one side of the conventional electronic device and there is another physical button such as a camera button positioned at the opposite side of the conventional electronic device, the user may confuse the camera button with the Power on/off button when the user is not seriously looking at the conventional electronic device, since the two buttons may be symmetrically distributed. In another example, after the conventional electronic device has been used for a period of time, the physical button may become insensitive due to oxidation of contact points of this physical button and/or a printed circuit board (PCB) of the conventional electronic device. Besides, a screen of the conventional electronic device may be automatically turned off for power saving while the user is still viewing contents on the screen. Thus, a novel method is required for improving the wake-up/screen-off mechanism of an electronic device.

### SUMMARY

It is therefore an objective of the claimed invention to provide a method for controlling an electronic device with aid of thermal detection, and an associated apparatus and an associated computer program product, in order to solve the above-mentioned problems.

It is another objective of the claimed invention to provide a method for controlling an electronic device with aid of thermal detection, and an associated apparatus and an associated computer program product, in order to allow the user to have various options of waking up the electronic device, not waking up the electronic device, controlling a screen of the electronic device to remain on, and turning off the screen of the electronic device.

It is another objective of the claimed invention to provide a method for controlling an electronic device with aid of thermal detection, and an associated apparatus and an associated computer program product, in order to allow the user to easily wake up the electronic device.

According to at least one preferred embodiment, a method for controlling an electronic device with aid of thermal detection is provided, where the comprises the steps of: performing thermal detection for the electronic device, to generate at least one thermal detection result; and based on the aforementioned at least one thermal detection result, selectively waking up the electronic device, not waking up the electronic device, controlling a screen of the electronic device to remain on, or turning off the screen of the electronic device.

According to at least one preferred embodiment, an apparatus for controlling an electronic device with aid of thermal detection is provided, where the apparatus comprises at least one portion of the electronic device. The apparatus comprises at least one thermal sensor, and further comprises a processing circuit that is coupled to the aforementioned at least one thermal sensor. The aforementioned at least one thermal sensor is capable of performing thermal detection for the electronic device, to generate at least one thermal detection result. In addition, the processing circuit is capable of, based on the aforementioned at least one thermal detection result, selectively waking up the electronic device, not waking up the electronic device, controlling a screen of the electronic device to remain on, or turning off the screen of the electronic device.

According to at least one preferred embodiment, a computer program product is provided, where the computer program product has program instructions for instructing a processing circuit of an electronic device to perform a method comprising the steps of: detecting whether one or more temperature measurement results within at least one thermal detection result obtained from at least one thermal sensor of the electronic device match a predetermined temperature pattern; and when it is detected that the one or more temperature measurement results match the predetermined temperature pattern, unlocking the electronic device.

According to at least one preferred embodiment, a method for controlling an electronic device with aid of thermal detection is provided, where the comprises the steps of: detecting whether a temperature measurement result within at least one thermal detection result obtained from at least one thermal sensor of the electronic device reaches a predetermined temperature threshold; and when it is detected that the temperature measurement result reaches the predetermined temperature threshold, controlling a screen of the electronic device to remain on.

According to at least one preferred embodiment, an apparatus for controlling an electronic device with aid of thermal detection is provided, where the apparatus comprises at least one portion of the electronic device. The apparatus comprises at least one thermal sensor, and further comprises a processing circuit that is coupled to the aforementioned at least one thermal sensor. The aforementioned at least one thermal sensor is capable of performing thermal detection for the electronic device, to generate at least one thermal detection result. In addition, the processing circuit is capable of detecting whether a temperature measurement result within the aforementioned at least one thermal detection result reaches a predetermined temperature threshold. Additionally, when it is detected that the temperature measurement result reaches the predetermined temperature threshold, the processing circuit controls a screen of the electronic device to remain on.

According to at least one preferred embodiment, a computer program product is provided, where the computer program product has program instructions for instructing a processing circuit of an electronic device to perform a method comprising the steps of: detecting whether a temperature measurement result within at least one thermal detection result obtained from at least one thermal sensor of the electronic device reaches a predetermined temperature threshold; and when it is detected that the temperature measurement result reaches the predetermined temperature threshold, controlling a screen of the electronic device to remain on.

It is an advantage of the present invention that the present invention method, the associated apparatus, and the associated computer program product can provide consistent user experience for end-users. In addition, the present invention method, the associated apparatus, and the associated computer program product allow the user to have various options of waking up the electronic device, not waking up the electronic device, controlling a screen of the electronic device to remain on, and turning off the screen of the electronic device. Additionally, the present invention method, the associated apparatus, and the associated computer program product allow the user to easily wake up the electronic device or control a screen of the electronic device to remain on, where related art problems (e.g. confusing one physical button with another, malfunction of a physical button, and screen being off while user is still viewing contents on the screen) can be prevented. In comparison with the related art, the present invention method, the associated apparatus, and the associated computer program product can save related costs such as material and labor costs, since the number of physical buttons can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an apparatus for controlling an electronic device with aid of thermal detection according to a first embodiment of the present invention.

FIG. 2 illustrates a multifunctional mobile phone involved with the apparatus shown in FIG. 1 according to an embodiment of the present invention.

FIG. 3 illustrates a flowchart of a method for controlling an electronic device with aid of thermal detection according to an embodiment of the present invention.

FIG. 4 illustrates a control scheme involved with the method shown in FIG. 3 according to an embodiment of the present invention.

FIG. 5 illustrates a working flow involved with the control scheme shown in FIG. 4 according to an embodiment of the present invention.

FIG. 6 illustrates a working flow involved with the control scheme shown in FIG. 4 according to another embodiment of the present invention.

FIG. 7 illustrates a control scheme involved with the method shown in FIG. 3 according to an embodiment of the present invention.

FIG. 8 illustrates a working flow involved with the control scheme shown in FIG. 7 according to an embodiment of the present invention.

FIG. 9 illustrates a control scheme involved with the method shown in FIG. 3 according to an embodiment of the present invention.

FIG. 10 illustrates a working flow involved with the control scheme shown in FIG. 9 according to an embodiment of the present invention.

FIG. 11 illustrates a working flow involved with the control scheme shown in FIG. 9 according to another embodiment of the present invention.

FIG. 12 illustrates a control scheme involved with the method shown in FIG. 3 according to an embodiment of the present invention.

FIG. 13 illustrates a working flow involved with the control scheme shown in FIG. 12 according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

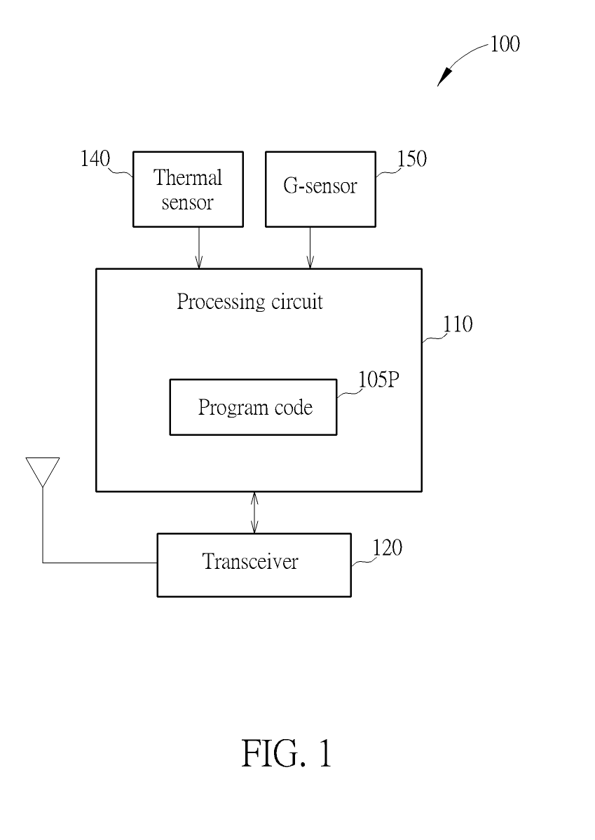

Please refer to FIG. 1, which illustrates a diagram of an apparatus 100 for controlling an electronic device with aid of thermal detection according to a first embodiment of the present invention, where the apparatus 100 may comprise at least one portion (e.g. a portion or all) of the electronic device. For example, the apparatus 100 may comprise a portion of the electronic device mentioned above, and more particularly, can be at least one hardware circuit such as at least one integrated circuit (IC) within the electronic device. In another example, the apparatus 100 can be the whole of the electronic device mentioned above. In another example, the apparatus 100 may comprise a system comprising the electronic device mentioned above (e.g. an audio/video system comprising the electronic device). Examples of the electronic device may include, but not limited to, a mobile phone (e.g. a multifunctional mobile phone), a personal digital assistant (PDA), a tablet, a wearable device and a personal computer such as a laptop computer.

As shown in FIG. 1, the apparatus 100 may comprise a processing circuit 110 which is capable of controlling one or more operations of the electronic device with aid of thermal detection, and may further comprise a transceiver 120 capable of transmitting and/or receiving information for the electronic device, where the transceiver 120 is coupled to the processing circuit 110, and one or more antennas of the electronic device may be coupled to the transceiver 120. For example, the processing circuit 110 may execute program code 105P (e.g. program instructions), and more particularly, may comprise at least one processor (e.g. one or more processors) such as a computer processor for executing the program code 105P, and the transceiver 120 may comprise a transmitter and a receiver such as those for wireless network communications. Though the program code 105P is shown in FIG. 1 as contained in the processing circuit 110, it can be stored in any storage located anywhere that the processing circuit 110 can access. According to this embodiment, the apparatus 100 may further comprise at least one thermal sensor 140 (e.g. one or more thermal sensors) and at least one G-sensor 150 (e.g. one or more G-sensors), where the aforementioned at least one thermal sensor 140 is capable of performing thermal detection for the electronic device, to generate at least one thermal detection result, and the aforementioned at least one G-sensor 150 is capable of generating at least one G-sensor detection result for the electronic device, for use of controlling the electronic device.

In some examples, the operations of controlling one or more operations of the electronic device with aid of thermal detection can be implemented with a specialized hardware circuit such as a customized IC, where the aforementioned specialized hardware circuit such as the customized IC mentioned above can be regarded as the processing circuit 110 of these examples.

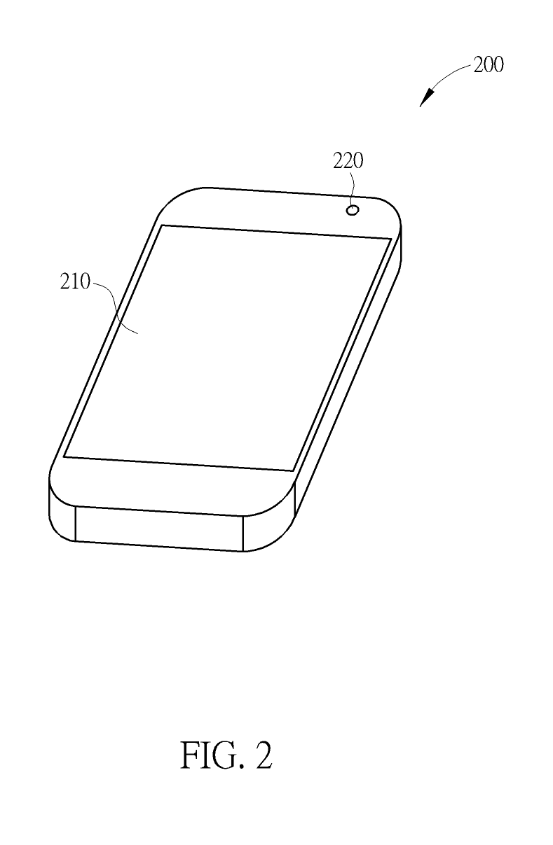

FIG. 2 illustrates a multifunctional mobile phone 200 involved with the apparatus 100 shown in FIG. 1 according to an embodiment of the present invention, where the multifunctional mobile phone 200 can be taken as an example of the electronic device mentioned above. As shown in FIG. 2, the multifunctional mobile phone 200 may comprise a touch sensitive display module 210 and a camera 220. This is for illustrative purposes only, and is not meant to be a limitation of the present invention.

According to some embodiments, the multifunctional mobile phone 200 can be taken as an example of the electronic device mentioned above. This is for illustrative purposes only, and is not meant to be a limitation of the present invention. According to some embodiments, any other electronic device (e.g. another type of electronic device, such as an electronic device that is not a multifunctional mobile phone) can be taken as an example of the electronic device mentioned above.

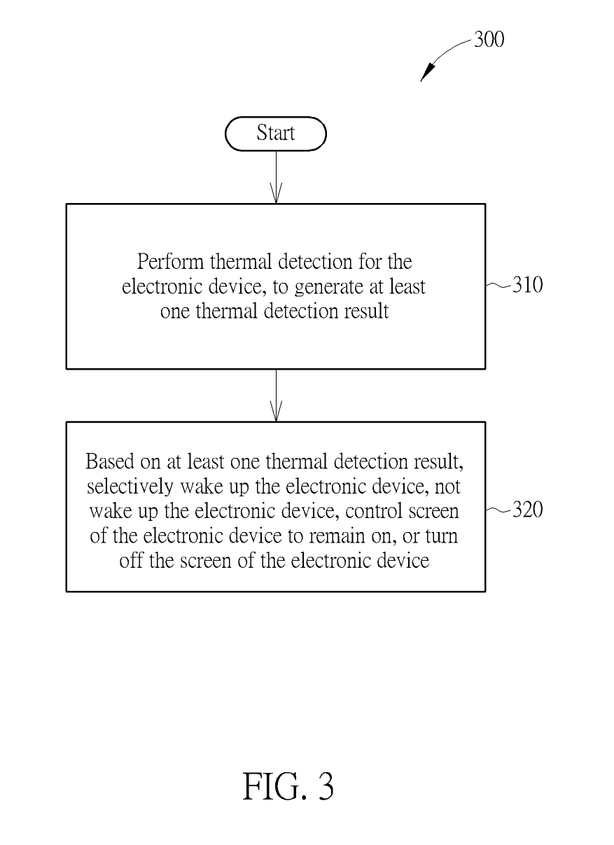

FIG. 3 illustrates a flowchart of a method 300 for controlling an electronic device with aid of thermal detection according to an embodiment of the present invention. The method 300 shown in FIG. 3 can be applied to the apparatus 100 shown in FIG. 1 (more particularly, the multifunctional mobile phone 200 of the embodiment shown in FIG. 2), and can be applied to the processing circuit 110 executing the program code 105P. For example, the program code 105P may be provided through a computer program product having program instructions (such as those mentioned above) for instructing a processing circuit such as that mentioned above to perform the method 300 shown in FIG. 3 (or at least one portion of operations of the method 300, such as one or more operations of any of the control schemes in the subsequent embodiments), where the computer program product may be implemented as a non-transitory computer-readable medium (e.g. a floppy disk or a compact disc-read only memory (CD-ROM)) storing the program instructions or an equivalent version thereof, such as a software package for being installed. This is for illustrative purposes only, and is not meant to be a limitation of the present invention. The method can be described as follows.

In Step 310, the processing circuit 110 utilizes the aforementioned at least one thermal sensor 140 (e.g. one or more thermal sensors) to perform thermal detection for the electronic device, to generate at least one thermal detection result (e.g. one or more thermal detection results). In practice, the aforementioned at least one thermal detection result may represent at least one temperature measurement result (e.g. one or more temperature measurement results).

In Step 320, based on the aforementioned at least one thermal detection result, the processing circuit 110 may selectively wake up the electronic device, not wake up the electronic device, control a screen of the electronic device to remain on, or turnoff the screen of the electronic device. For example, based on the aforementioned at least one thermal detection result, the processing circuit 110 may selectively wake up the electronic device. This is for illustrative purposes only, and is not meant to be a limitation of the present invention. In another example, based on the aforementioned at least one thermal detection result, the processing circuit 110 may selectively not wake up the electronic device, and more particularly, may prevent from waking up the electronic device. In another example, based on the aforementioned at least one thermal detection result, the processing circuit 110 may selectively control the screen of the electronic device to remain on, and more particularly, may prevent from turning off the screen of the electronic device. In another example, based on the aforementioned at least one thermal detection result, the processing circuit 110 may selectively turn off the screen of the electronic device.

More particularly, in response to at least one activity of the user of the electronic device (e.g. one or more activities of the user), the aforementioned at least one thermal detection result such as the aforementioned at least one temperature measurement result may satisfy a specific condition or not. For example, in a situation where the aforementioned at least one thermal detection result such as the aforementioned at least one temperature measurement result satisfies the specific condition, the processing circuit 110 may wake up the electronic device. This is for illustrative purposes only, and is not meant to be a limitation of the present invention. In another example, in a situation where the aforementioned at least one thermal detection result such as the aforementioned at least one temperature measurement result does not satisfy this specific condition, the processing circuit 110 may prevent waking up the electronic device.

In some embodiments, ‘the electronic device such as the multifunctional mobile phone 200 is asleep’ may mean that the screen of the electronic device is off while a portion or the entirety of the remainder of the electronic device may or may not be in a power saving mode. In some embodiments, ‘the electronic device such as the multifunctional mobile phone 200 is awake’ may mean that the screen of the electronic device is on and a portion or the entirety of the remainder of the electronic device is awake to process following requests.

In one embodiment the processing circuit 110 can be implemented to be capable of ‘falling asleep’, which typically means the processing circuit 110 is in a non-working mode such as a power saving mode. In a situation where the processing circuit 110 falls asleep (and therefore the electronic device seems to be sleeping to the user), the processing circuit 110 may selectively wake up based on the aforementioned at least one thermal detection result. For example, the processing circuit 110 may be woken up by another component or be scheduled to wake up. This is for illustrative purposes only, and is not meant to be a limitation of the present invention. In some other examples, the electronic device can be implemented to be capable of ‘falling asleep’, without controlling the processing circuit 110 to enter the non-working mode such as the power saving mode. In a situation where the electronic device falls asleep (e.g. the touch sensitive display module 210 is turned off, and therefore the electronic device seems to be sleeping to the user), the processing circuit 110 may selectively wake up the electronic device based on the aforementioned at least one thermal detection result.

According to this embodiment, the aforementioned at least one thermal detection result may comprise a temperature measurement result. For example, when the temperature measurement result reaches a predetermined temperature threshold, the processing circuit 110 may wake up the electronic device and/or turn on the screen of the electronic device (e.g. the touch sensitive display module 210) to allow the user of the electronic device to interact with the electronic device. More particularly, when the temperature measurement result reaches the predetermined temperature threshold, the processing circuit 110 may wake up the electronic device and/or turn on the screen of the electronic device to allow the user of the electronic device to interact with the electronic device; otherwise, the processing circuit 110 may prevent the screen of the electronic device from being turned on. This is for illustrative purposes only, and is not meant to be a limitation of the present invention. In some other examples, a plurality of detection results obtained from multiple sensors of the electronic device (e.g. the aforementioned at least one thermal sensor 140 and/or the aforementioned at least one G-sensor 150) may comprise the temperature measurement result, where the plurality of detection results may indicate that the user of the electronic device is going to use the electronic device.

In some other examples, based on the aforementioned at least one thermal detection result and at least one G-sensor detection result obtained from the aforementioned at least one G-sensor 150 of the electronic device, the processing circuit 110 may selectively wake up the electronic device. For example, when the temperature measurement result reaches the predetermined temperature threshold and the aforementioned at least one G-sensor detection result matches a predetermined rule, the processing circuit 110 may wake up the electronic device and/or turn on the screen of the electronic device to allow the user of the electronic device to interact with the electronic device. More particularly, when the temperature measurement result reaches the predetermined temperature threshold and the aforementioned at least one G-sensor detection result matches the predetermined rule, the processing circuit 110 may wake up the electronic device and turn on the screen of the electronic device to allow the user of the electronic device to interact with the electronic device; otherwise, the processing circuit 110 may prevent the screen of the electronic device from being turned on. This is for illustrative purposes only, and is not meant to be a limitation of the present invention.

According to some embodiments, regarding the operation of detecting whether the temperature measurement result reaches the predetermined temperature threshold, reaching the predetermined temperature threshold may represent that the temperature increases to reach the predetermined temperature threshold. For example, in a situation where the temperature of the hand of the user is greater than the original temperature of the electronic device (e.g. the ambient temperature), when the user holds the electronic device, the temperature of the case (or shell) of the electronic device may increase to reach the predetermined temperature threshold. This is for illustrative purposes only, and is not meant to be a limitation of the present invention. According to some embodiments, regarding the operation of detecting whether the temperature measurement result reaches the predetermined temperature threshold, reaching the predetermined temperature threshold may represent that the temperature decreases to reach the predetermined temperature threshold. For example, in a situation where the temperature of the hand of the user is less than the original temperature of the electronic device (e.g. the ambient temperature), when the user holds the electronic device, the temperature of the case (or shell) of the electronic device may decrease to reach the predetermined temperature threshold.

According to some embodiments, the operation of detecting whether the temperature measurement result reaches the predetermined temperature threshold can be replaced by the operation of detecting whether the variation of the temperature measurement result reaches a predetermined threshold such as a predetermined temperature variation threshold.

In some embodiments, the processing circuit 110 may wake up the electronic device and turn on the screen of the electronic device. In addition, the processing circuit 110 may prevent the screen from displaying a slide-unlock-related hint, to allow the user of the electronic device to use the electronic device without slide-unlocking the electronic device.

In some embodiments, the processing circuit 110 may wake up the electronic device and turn on the screen of the electronic device. In addition, the processing circuit 110 may control the screen to display an unlock-related hint, to allow the user of the electronic device to try unlocking the electronic device.

In some embodiments, the aforementioned at least one thermal detection result may comprise at least one temperature measurement result (e.g. one or more temperature measurement results), which can be taken as an example of the aforementioned one or more temperature measurement results. The processing circuit 110 may detect whether the aforementioned at least one temperature measurement result (e.g. the one or more temperature measurement results mentioned above) matches a predetermined temperature pattern. In addition, when it is detected that the aforementioned at least one temperature measurement result matches the predetermined temperature pattern, the processing circuit 110 may unlock the electronic device. This is for illustrative purposes only, and is not meant to be a limitation of the present invention. In some embodiments, when it is detected that the aforementioned at least one temperature measurement result matches the predetermined temperature pattern, the processing circuit 110 may wake up the electronic device.

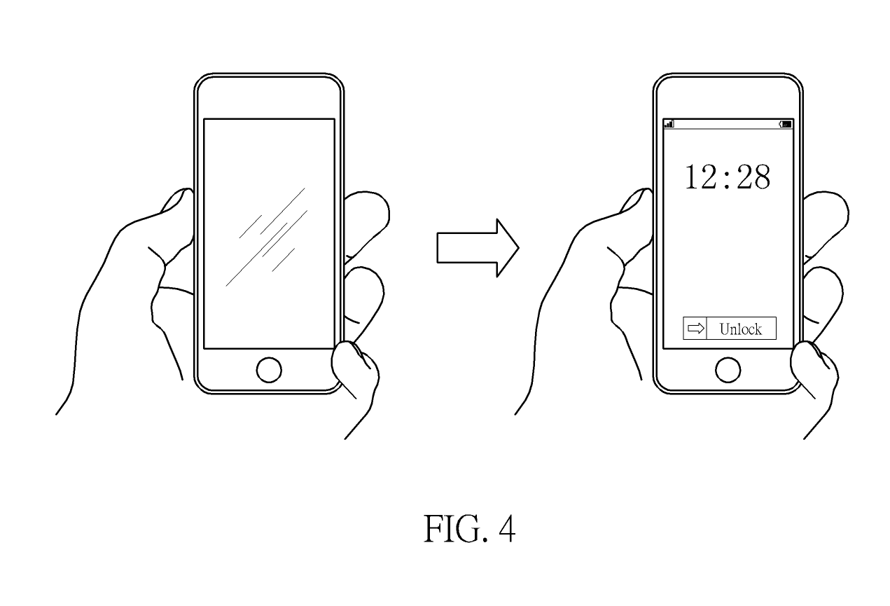

FIG. 4 illustrates a control scheme involved with the method 300 shown in FIG. 3 according to an embodiment of the present invention. In response to the aforementioned at least one activity of the user of the electronic device (e.g. the user picks up the electronic device such as the multifunctional mobile phone 200 shown in FIG. 2), the aforementioned at least one thermal detection result such as the aforementioned at least one temperature measurement result may satisfy the specific condition. For example, when the temperature measurement result reaches the predetermined temperature threshold, the processing circuit 110 may wake up the electronic device and/or turn on the screen of the electronic device (e.g. the touch sensitive display module 210) to allow the user of the electronic device to interact with the electronic device. Therefore the user may not need to push the physical button to wake up the electronic device and/or turn on the screen of the electronic device. This is for illustrative purposes only, and is not meant to be a limitation of the present invention.

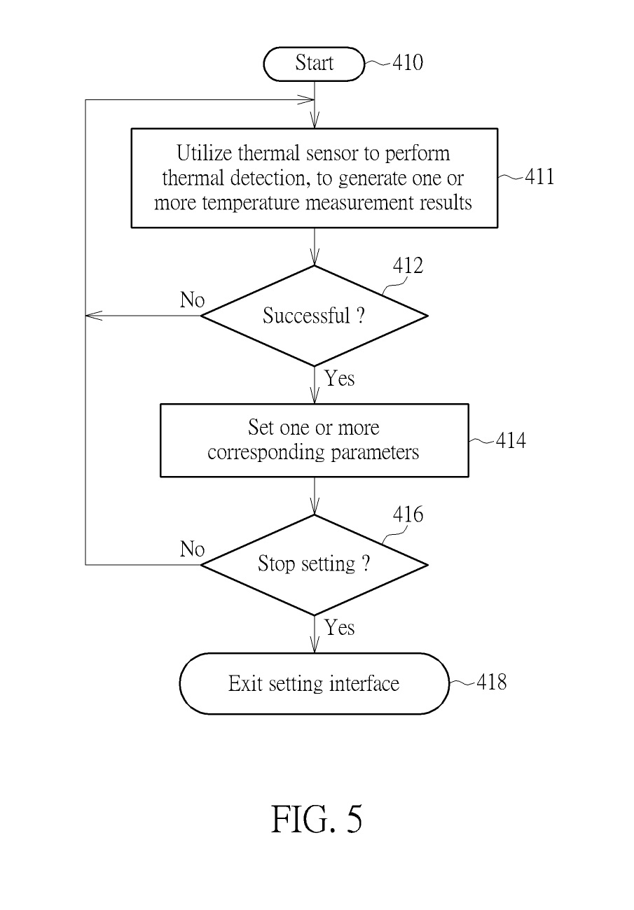

FIG. 5 illustrates a working flow involved with the control scheme shown in FIG. 4 according to an embodiment of the present invention.

In Step 410, the working flow shown in FIG. 5 starts. During the working flow shown in FIG. 5, the processing circuit 110 may perform one or more thermal detection setting operations (e.g. the setting operation (s) of Step 414). For example, the processing circuit 110 may trigger a hint regarding thermal detection setting for the user, such as one or more guidance messages within a setting interface displayed on the screen.

In Step 411, the processing circuit 110 may utilize the aforementioned at least one thermal sensor 140 to perform thermal detection, to generate one or more temperature measurement results such as that mentioned above.

In Step 412, the processing circuit 110 may check whether the thermal detection is successful, and more particularly, check whether the thermal detection is performed successfully by checking whether one or more temperature measurement results is generated. When it is detected that the thermal detection is successful, Step 414 is entered; otherwise, Step 411 is re-entered.

In Step 414, the processing circuit 110 may set one or more corresponding parameters, such as one or more parameters associated to the one or more temperature measurement results mentioned in Step 411. More particularly, the processing circuit 110 may set one or more thermal detection parameters based on the one or more temperature measurement results mentioned in Step 411.

In Step 416, the processing circuit 110 may check whether to stop setting, and more particularly determines whether to stop setting in response to the reply from the user. When it is detected that stopping setting is required, Step 418 is entered; otherwise, Step 411 is re-entered.

In Step 418, the processing circuit 110 may exit the setting interface.

According to this control scheme, examples of the one or more parameters mentioned in Step 414 may comprise: the mobile phone temperature, the user's body temperature, the ambient temperature, various types of time parameters (e.g. a day in a year, the exact time in a day, a time period in a day such as any of the morning period, the afternoon period, and the evening period, etc.), geographical data, (e.g. the longitude, the latitude, the altitude, etc.), weather data (e.g. the season, the temperature, the humidity, and a type of weather such as sunny, rainy, cloudy, and snowy, etc.), and so on. This is for illustrative purposes only, and is not meant to be a limitation of the present invention.

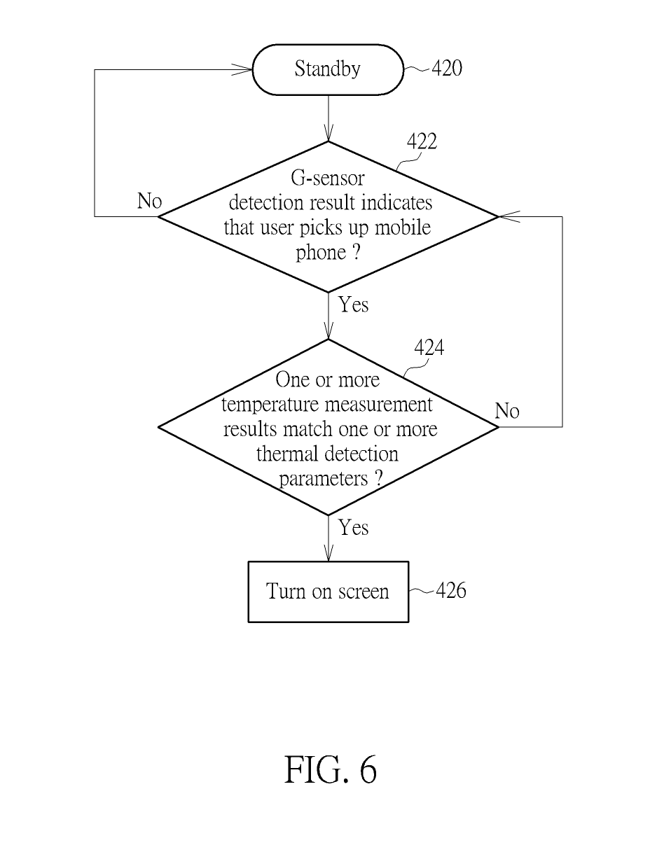

FIG. 6 illustrates a working flow involved with the control scheme shown in FIG. 4 according to another embodiment of the present invention.

In Step 420, the electronic device such as the multifunctional mobile phone 200 may be in a standby status (e.g. the status of sleeping). For example, in a situation where the processing circuit 110 falls asleep (and therefore the electronic device seems to be sleeping to the user), the processing circuit 110 may selectively be woken up by another component or selectively be scheduled to wake up. According to the working flow shown in FIG. 6, the processing circuit 110 may selectively wake up the electronic device based on the aforementioned at least one thermal detection result. This is for illustrative purposes only, and is not meant to be a limitation of the present invention. In some other examples, in a situation where the electronic device falls asleep (e.g. the touch sensitive display module 210 is turned off, and therefore the electronic device seems to be sleeping to the user), according to the working flow shown in FIG. 6, the processing circuit 110 may selectively wake up the electronic device based on the aforementioned at least one thermal detection result.

In Step 422, the processing circuit 110 may check whether the aforementioned at least one G-sensor detection result indicates that the user picks up the electronic device (e.g. the multifunctional mobile phone 200). When it is detected that the aforementioned at least one G-sensor detection result indicates that the user picks up the electronic device (e.g. the multifunctional mobile phone 200), Step 424 is entered; otherwise, Step 422 is re-entered. Please note that in some embodiments, the Step 422 may be omitted and the outward arrow from Step 420 may be redirected toward Step 424.

In Step 424, the processing circuit 110 may check whether one or more temperature measurement results such as that mentioned above match one or more thermal detection parameters such as that of the embodiment shown in FIG. 5. When it is detected that the aforementioned one or more temperature measurement results match the aforementioned one or more thermal detection parameters, Step 426 is entered; otherwise, Step 422 is re-entered if Step 422 is not omitted in this embodiment or Step 420 is re-entered if Step 422 is omitted in some embodiments.

In Step 426, the processing circuit 110 may turn on the screen such as the touch sensitive display module 210.

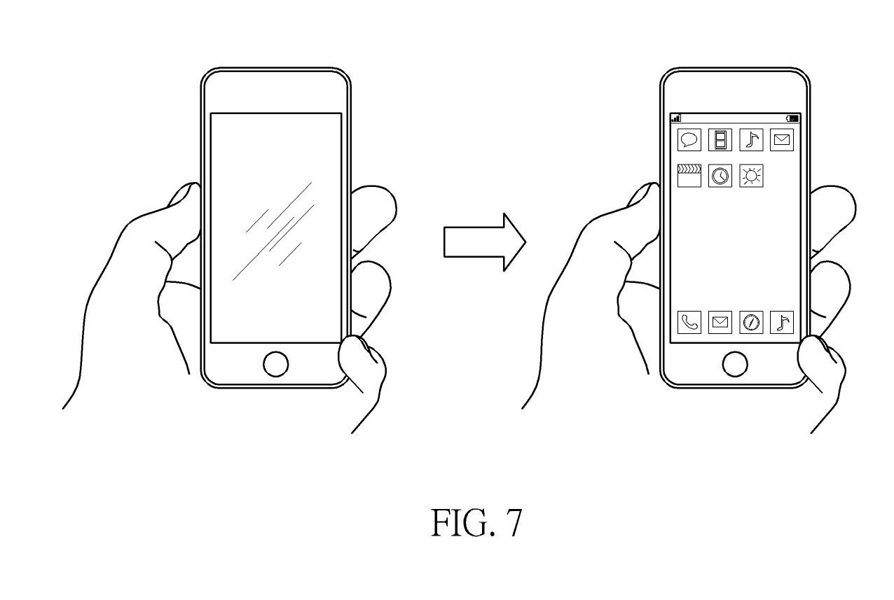

FIG. 7 illustrates a control scheme involved with the method 300 shown in FIG. 3 according to an embodiment of the present invention. In response to the aforementioned at least one activity of the user of the electronic device (e.g. the user picks up the electronic device such as the multifunctional mobile phone 200 shown in FIG. 2), the aforementioned at least one thermal detection result such as the aforementioned at least one temperature measurement result may satisfy the specific condition. For example, when the temperature measurement result reaches the predetermined temperature threshold, the processing circuit 110 may wake up the electronic device and/or turn on the screen of the electronic device (e.g. the touch sensitive display module 210) to allow the user of the electronic device to interact with the electronic device. More particularly, when the temperature measurement result reaches the predetermined temperature threshold, the processing circuit 110 may wake up the electronic device and turn on the screen of the electronic device (e.g. the touch sensitive display module 210), and more particularly, switches to the Home screen or the screen content last time the user saw, to allow the user of the electronic device to start using the electronic device.

In one example, the electronic device such as the multifunctional mobile phone 200 may have been set so that the user may not need to deal with security lock when he/she starts using the electronic device. ‘A device has security lock’ may mean that the user has to pass some security check to unlock the device such as pattern, PIN, password, face unlock, voice unlock, and so on. Then the processing circuit 110 may control the screen to display only the non-security-unlock-related hint such as a slide-unlock-related hint. ‘A device has non-security lock’ may mean that the user could unlock the screen by using a simple gesture such as slide-unlock. In another example, the electronic device such as the multifunctional mobile phone 200 may have been set so that the user may even not need to slide-unlock when he/she starts using the electronic device. Then the processing circuit 110 may prevent the screen from displaying the slide-unlock-related hint, to allow the user of the electronic device to use the electronic device without slide-unlocking the electronic device. This is for illustrative purposes only, and is not meant to be a limitation of the present invention.

In practice, the processing circuit 110 of the embodiment shown in FIG. 7 may perform one or more thermal detection setting operations such as that mentioned in the embodiment shown in FIG. 5, and more particularly, may perform the operations of the working flow shown in FIG. 5. As a result, the processing circuit 110 of the embodiment shown in FIG. 7 may obtain one or more thermal detection parameters such as that mentioned in the embodiment shown in FIG. 5. For brevity, similar descriptions for this embodiment are not repeated in detail here.

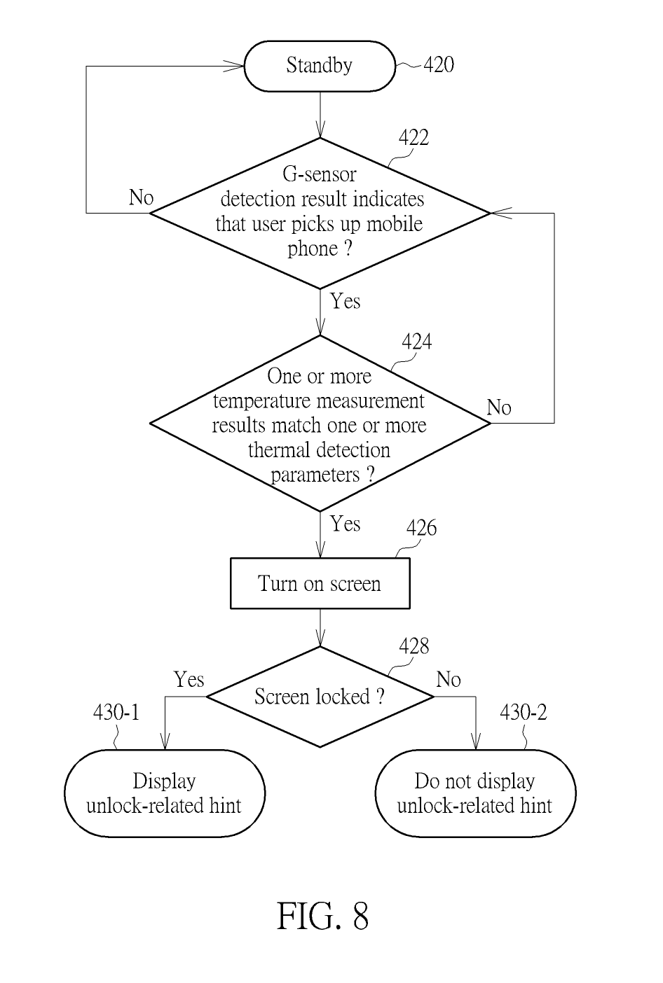

FIG. 8 illustrates a working flow involved with the control scheme shown in FIG. 7 according to an embodiment of the present invention.

The Steps 420-426 are similar to those shown in FIG. 6, so descriptions for them are not repeated in detail here for brevity.

In Step 428, the processing circuit 110 may check whether the screen is locked (for example, via various types of lock, such as security lock and/or non-security lock). When it is detected that the screen is locked, Step 430-1 is entered; otherwise, Step 430-2 is entered.

In Step 430-1, the processing circuit 110 may control the screen (e.g. the touch sensitive display module 210) to display the unlock-related hint.

In Step 430-2, the processing circuit 110 may control the screen (e.g. the touch sensitive display module 210) to not display the unlock-related hint.

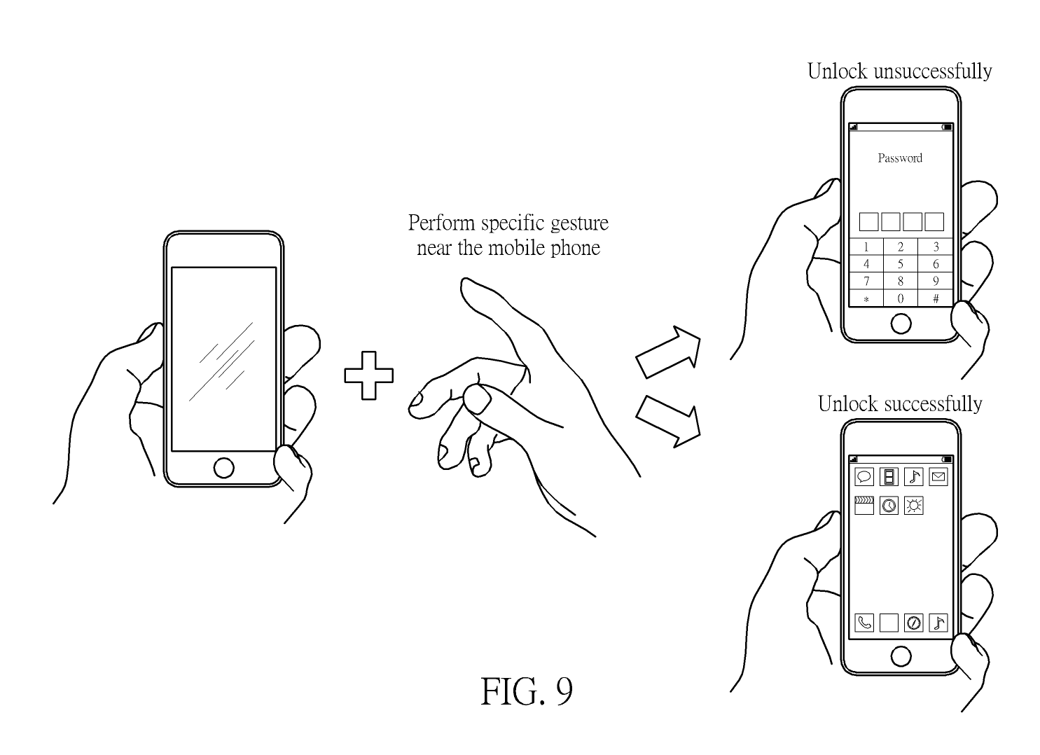

FIG. 9 illustrates a control scheme involved with the method 300 shown in FIG. 3 according to an embodiment of the present invention. In response to the aforementioned at least one activity of the user of the electronic device (e.g. the user picks up the electronic device such as the multifunctional mobile phone 200 shown in FIG. 2), the aforementioned at least one thermal detection result such as the aforementioned at least one temperature measurement result may satisfy the specific condition. For example, when the temperature measurement result reaches the predetermined temperature threshold, the processing circuit 110 may enter an unlock-gesture detection procedure. More particularly, the processing circuit 110 may detect whether at least one temperature measurement result such as that mentioned above matches a predetermined temperature pattern for the unlock-gesture detection procedure, such as the predetermined temperature pattern mentioned above. In addition, when it is detected that the aforementioned at least one temperature measurement result matches the predetermined temperature pattern, the processing circuit 110 may unlock the electronic device.

For example, the electronic device such as the multifunctional mobile phone 200 may have been set to have a screen lock, and the user is supposed to pass the unlock-gesture check of the unlock-gesture detection procedure before he/she starts using the electronic device. More particularly, the user may perform a specific gesture near the electronic device such as the multifunctional mobile phone 200 (e.g. the user may use one of his/her hands to hold the multifunctional mobile phone 200, and move the other of his/her hands to perform the specific gesture without touching the touch sensitive display module 210), and the processing circuit 110 may check whether the specific gesture matches a predetermined gesture based on thermal detection, by determining whether the aforementioned at least one temperature measurement result matches the predetermined temperature pattern for the unlock-gesture detection procedure.

As shown in FIG. 9, in a situation where the user passes the unlock-gesture check of the unlock-gesture detection procedure, the user unlocks the multifunctional mobile phone 200 successfully. As a result, the processing circuit 110 may turn on the screen of the electronic device (e.g. the touch sensitive display module 210) to allow the user of the electronic device to start using the electronic device. In addition, in a situation where the user fails to pass the unlock-gesture check of the unlock-gesture detection procedure, the user unlocks the multifunctional mobile phone 200 unsuccessfully. As a result, the processing circuit 110 may turn on the screen of the electronic device (e.g. the touch sensitive display module 210) and enter a backup unlock-procedure such as a conventional password check, to allow the user of the electronic device to try unlocking the electronic device with a password. This is for illustrative purposes only, and is not meant to be a limitation of the present invention.

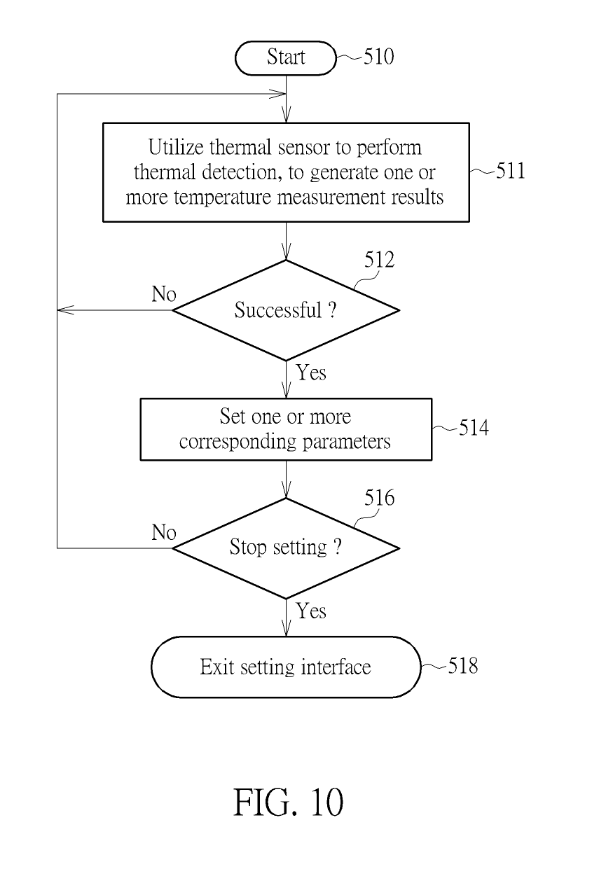

FIG. 10 illustrates a working flow involved with the control scheme shown in FIG. 9 according to an embodiment of the present invention.

In Step 510, the working flow shown in FIG. 10 starts. During the working flow shown in FIG. 10, the processing circuit 110 may perform one or more thermal detection gesture-unlocking setting operations (e.g. the setting operation(s) of Step 514). For example, the processing circuit 110 may trigger a hint regarding thermal detection setting control for the user, such as one or more guidance messages within a setting interface displayed on the screen.

In Step 511, the processing circuit 110 may utilize the aforementioned at least one thermal sensor 140 to perform thermal detection, to generate one or more temperature measurement results such as that mentioned above.

In Step 512, the processing circuit 110 may check whether the thermal detection is successful, and more particularly, checks whether the thermal detection is performed successfully by checking whether one or more temperature measurement results is generated. When it is detected that the thermal detection is successful, Step 514 is entered; otherwise, Step 511 is re-entered.

In Step 514, the processing circuit 110 may set one or more corresponding parameters, such as one or more parameters associated to the one or more temperature measurement results mentioned in Step 511. More particularly, the processing circuit 110 may set one or more thermal detection parameters based on the one or more temperature measurement results mentioned in Step 511.

In Step 516, the processing circuit 110 may check whether to stop setting, and more particularly determine whether to stop setting in response to the reply from the user. When it is detected that stopping setting is required, Step 518 is entered; otherwise, Step 511 is re-entered.

In Step 518, the processing circuit 110 may exit the setting interface.

According to this control scheme, examples of the one or more parameters mentioned in Step 514 may comprise: the type of gesture (or user action), the mobile phone temperature, the user's body temperature, the ambient temperature, various types of time parameters (e.g. a day in a year, the exact time in a day, a time period in a day such as any of the morning period, the afternoon period, and the evening period, etc.), geographical data, (e.g. the longitude, the latitude, the altitude, etc.), weather data (e.g. the season, the temperature, the humidity, and a type of weather such as sunny, rainy, cloudy, and snowy, etc.), and so on. This is for illustrative purposes only, and is not meant to be a limitation of the present invention.

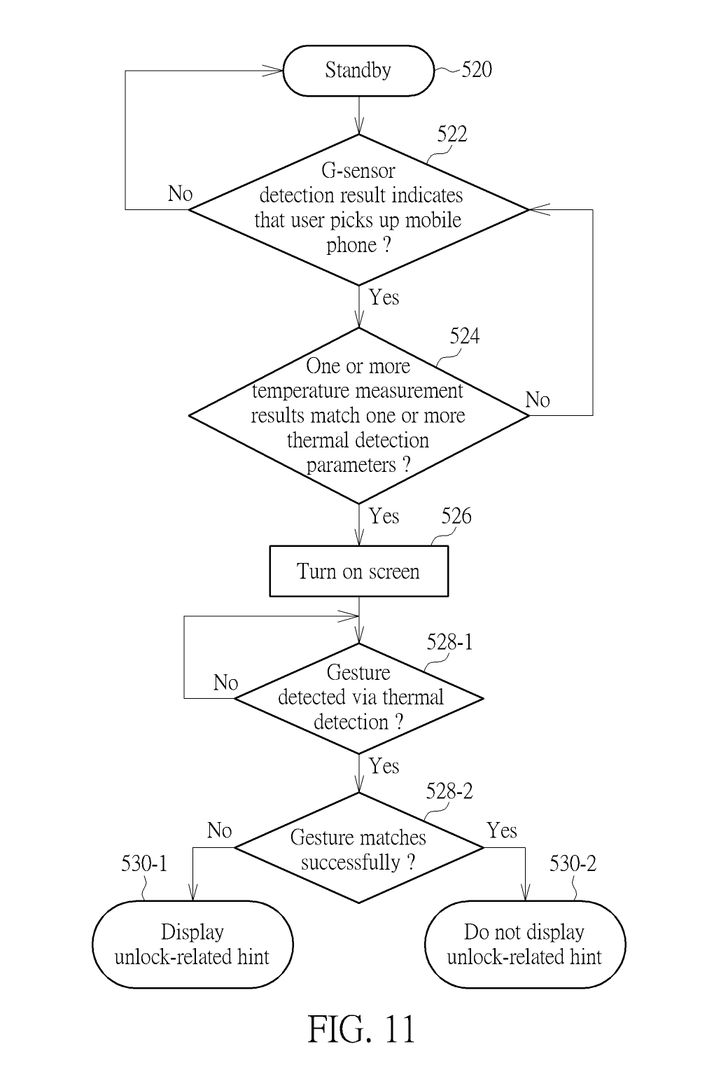

FIG. 11 illustrates a working flow involved with the control scheme shown in FIG. 9 according to another embodiment of the present invention.

Steps 520 and 522 are similar to Steps 420 and 422 in FIG. 6, so descriptions for them are not repeated in detail here for brevity.

In Step 524, the processing circuit 110 may check whether one or more temperature measurement results such as that mentioned above match one or more thermal detection parameters that are set in advance, such as one or more thermal detection parameters generated in the aforementioned one or more thermal detection gesture-unlocking setting operations mentioned in the embodiment shown in FIG. 10. When it is detected that the one or more temperature measurement results match the one or more thermal detection parameters of this embodiment, Step 526 is entered; otherwise, Step 522 is re-entered if Step 522 is not omitted in this embodiment or Step 520 is re-entered if Step 522 is omitted in some embodiments.

In Step 526, the processing circuit 110 may turn on the screen such as the touch sensitive display module 210.

In Step 528-1, the processing circuit 110 may check whether a gesture is detected via thermal detection. When a gesture is detected via thermal detection, Step 528-2 is entered; otherwise, Step 528-1 is re-entered.

In Step 528-2, the processing circuit 110 may check whether the gesture mentioned in Step 528-1 matches successfully, and more particularly, check whether the gesture mentioned in Step 528-1 matches the predetermined gesture mentioned above. When it is detected that the gesture mentioned in Step 528-1 matches the predetermined gesture, Step 530-2 is entered; otherwise, Step 530-1 is entered.

In Step 530-1, the processing circuit 110 may control the screen (e.g. the touch sensitive display module 210) to display the unlock-related hint. More particularly, in a situation where the user fails to pass the unlock-gesture check of the unlock-gesture detection procedure mentioned above, the user may have to unlock the multifunctional mobile phone 200 in another way that hinted by the unlock-related hint.

In Step 530-2, the processing circuit 110 may control the screen (e.g. the touch sensitive display module 210) to not display the unlock-related hint. More particularly, in a situation where the user passes the unlock-gesture check of the unlock-gesture detection procedure mentioned above, the user unlocks the multifunctional mobile phone 200 successfully and thus a further unlock-related hint is not needed.

According to this embodiment, the operation of Step 526 can be performed before those of Step 528-2, Step 530-1, and Step 530-2. This is for illustrative purposes only, and is not meant to be a limitation of the present invention. According some variations of this embodiment, the operation of Step 526 can be performed after that of Step 528-2. For example, Step 526 can be inserted between Step 528-2 and Step 530-1, and can be inserted between Step 528-2 and Step 530-2.

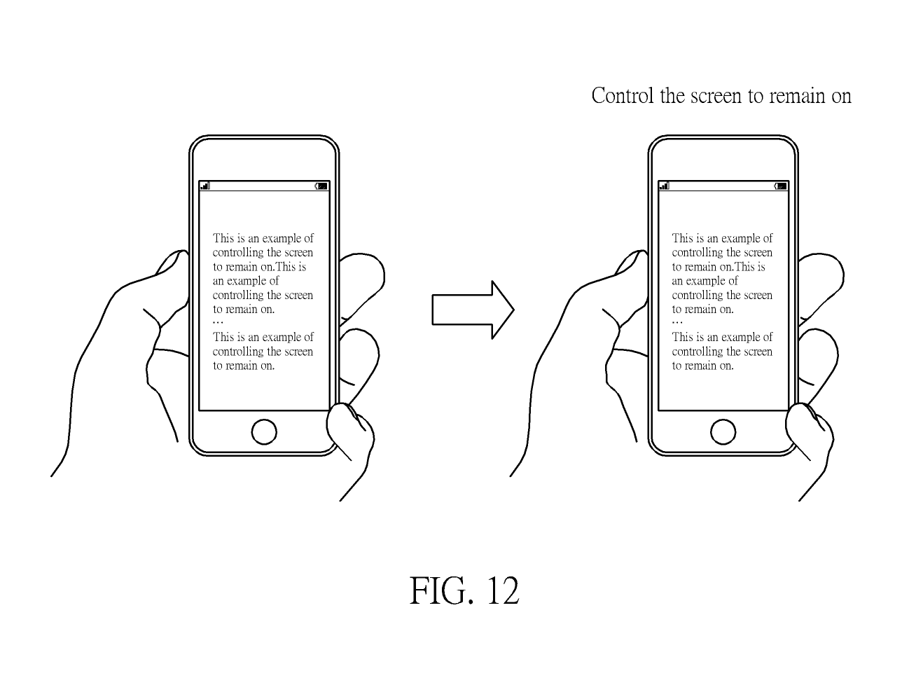

FIG. 12 illustrates a control scheme involved with the method 300 shown in FIG. 3 according to an embodiment of the present invention. In this embodiment, based upon thermal detection such as that mentioned in Step 310, the processing circuit 110 can prevent the electronic device such as the multifunctional mobile phone 200 from falling asleep. More particularly, in response to at least one activity of the user of the electronic device (e.g. one or more activities of the user), at least one thermal detection result obtained from the aforementioned at least one thermal sensor 140, such as at least one temperature measurement result, may satisfy a specific condition (e.g. the specific condition mentioned in the embodiment shown in FIG. 3) or not. For example, in a situation where the aforementioned at least one thermal detection result such as the aforementioned at least one temperature measurement result satisfies the specific condition, the processing circuit 110 may control the screen of the electronic device to remain on.

Thus, based on the aforementioned at least one thermal detection result in this embodiment, the processing circuit 110 may selectively control the screen such as the touch sensitive display module 210 to remain on. More particularly, the processing circuit 110 may detect whether a temperature measurement result within the aforementioned at least one thermal detection result of this embodiment reaches a predetermined temperature threshold such as that mentioned above. When it is detected that the temperature measurement result within the aforementioned at least one thermal detection result of this embodiment reaches the predetermined temperature threshold, the processing circuit 110 may control the screen of the electronic device to remain on. For example, in a situation where the user is holding the multifunctional mobile phone 200 and reading an electronic book on it, after the user reads for a while (e.g. five minutes or longer), the processing circuit 110 may control the screen such as the touch sensitive display module 210 to remain on since the user's body temperature may allow the thermal detection result to reach the predetermined temperature threshold. Therefore, the user does not need to touch the screen to keep the screen on as they did to a conventional mobile phone. As a result, the user can continue reading the electronic book with ease, and will not be forced to intermittently touch the screen when he/she is reading.

Please note that the strings of “This is an example of controlling the screen to remain on” shown in FIG. 12 can be taken as examples of the contents shown on the screen. This is for illustrative purposes only, and is not meant to be a limitation of the present invention. In some other examples, the contents shown on the screen may vary. In addition, in this embodiment, reading the contents can be taken as an example of what the user is doing. This is for illustrative purposes only, and is not meant to be a limitation of the present invention. In some embodiments, what the user is doing may vary. For example, in a situation where the user is playing a game by using the multifunctional mobile phone 200, after the user uses the multifunctional mobile phone 200 for a while (e.g. the user is waiting for something in the game, for five minutes or longer), the processing circuit 110 may control the screen such as the touch sensitive display module 210 to remain on, where the user does not need to touch the screen. As a result, the user can continue playing the game, and will not be forced to intermittently touch the screen when he/she is playing the game.

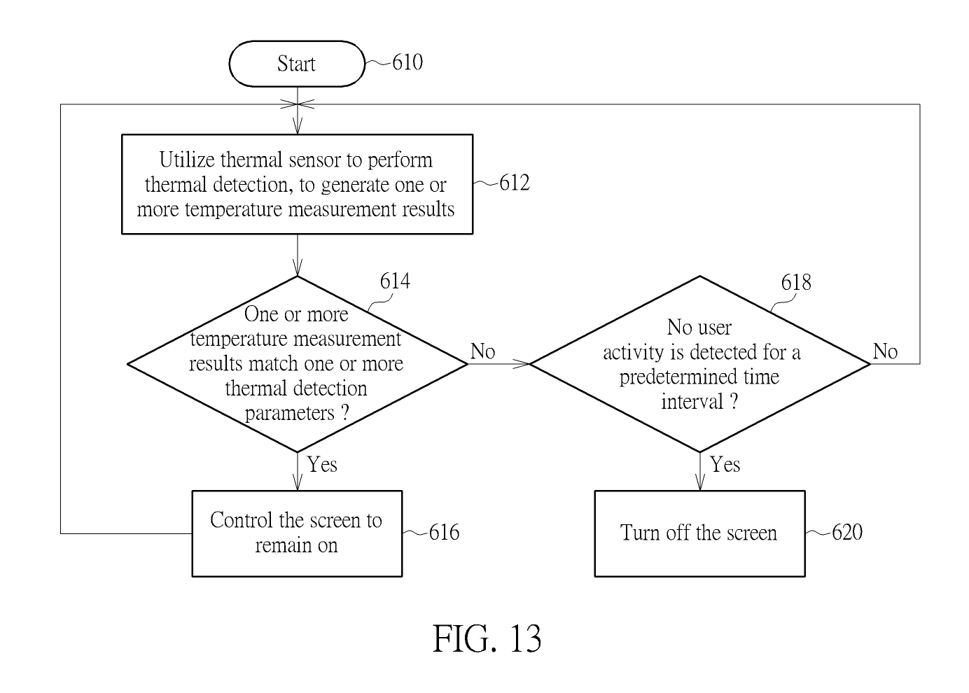

FIG. 13 illustrates a working flow involved with the control scheme shown in FIG. 12 according to an embodiment of the present invention.

In Step 610, the processing circuit 110 may start the procedure of selectively controlling the screen such as the touch sensitive display module 210 to remain on.

In Step 612, the processing circuit 110 may utilize the aforementioned at least one thermal sensor 140 (e.g. one or more thermal sensors) to perform thermal detection, to generate one or more temperature measurement results, which may be similar to that mentioned in the descriptions for Step 310.

In Step 614, the processing circuit 110 may check whether the aforementioned one or more temperature measurement results of Step 612 match one or more thermal detection parameters such as that of the embodiment shown in FIG. 5. When it is detected that the one or more temperature measurement results match the one or more thermal detection parameters, Step 616 is entered; otherwise, Step 618 is entered.

In Step 616, the processing circuit 110 may control the screen to remain on. For example, the processing circuit 110 may emulate a user activity by utilizing a wake lock (e.g. a poke wake lock). In other embodiments, the processing circuit 110 may grab wake lock to keep the screen on (e.g. when the user is playing a game) and release wake lock (so the screen may be off after a period of time in a situation where no further user activity is detected) when exiting the application. Implementation details of the wake lock are well known in the related art, and therefore are not repeated in detail here.

In Step 618, the processing circuit 110 may check whether no user activity is detected for a predetermined time interval. When it is determined that no user activity is detected for the predetermined time interval, Step 620 is entered; otherwise, Step 612 is re-entered.

In Step 620, the processing circuit 110 may turn off the screen such as the touch sensitive display module 210.

Please note that, in the embodiment shown in FIG. 13, the operation of utilizing the aforementioned wake lock (e.g. the poke wake lock mentioned above) can be taken as an example of the implementation details of the operation of emulating the user activity. This is for illustrative purposes only, and is not meant to be a limitation of the present invention. According to some embodiments, another operation that is different from the operation of utilizing the aforementioned wake lock can be utilized for emulating the user activity.

In addition, in the embodiment shown in FIG. 13, the operation of emulating the user activity can be taken as an example of the implementation details of the operation of controlling the screen to remain on. This is for illustrative purposes only, and is not meant to be a limitation of the present invention. According to some embodiments, another operation that is different from the operation of emulating the user activity can be utilized for controlling the screen to remain on.

Additionally, in the embodiment shown in FIG. 13, the operation of Step 614 can be performed before the operation of Step 618 is performed. This is for illustrative purposes only, and is not meant to be a limitation of the present invention. According to some embodiments, the operation of Step 618 can be performed before the operation of Step 614 is performed. More particularly, in these embodiments, Step 618 can be entered first after the operation of Step 612 is performed. In addition, in Step 618 of these embodiments, when it is determined that no user activity is detected for the predetermined time interval, Step 614 is entered; otherwise, Step 620 is entered. Additionally, in Step 614 of these embodiments, when it is detected that the one or more temperature measurement results match the one or more thermal detection parameters, Step 616 is entered; otherwise, Step 612 is re-entered.

According to some embodiments, the associated working flows may be illustrated as described above. This is for illustrative purposes only, and is not meant to be a limitation of the present invention. According to some embodiments, the order of performing the operations of the steps in any of the associated working flows may vary. According to some embodiments, one or more steps may be omitted. According to some embodiments, one or more steps may be added.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling an electronic device with aid of thermal detection, the method comprising the steps of:
performing thermal detection for the electronic device, to generate at least one thermal detection result; and
based on the at least one thermal detection result, selectively waking up the electronic device, not waking up the electronic device, controlling a screen of the electronic device to remain on, or turning off the screen of the electronic device.

2. The method of claim 1, wherein the at least one thermal detection result comprises a temperature measurement result; and the step of selectively waking up the electronic device, not waking up the electronic device, controlling the screen of the electronic device to remain on, or turning off the screen of the electronic device further comprises:
when the temperature measurement result reaches a predetermined temperature threshold, waking up the electronic device or controlling the screen of the electronic device to remain on.

3. The method of claim 1, wherein the step of selectively waking up the electronic device, not waking up the electronic device, controlling the screen of the electronic device to remain on, or turning off the screen of the electronic device further comprises:
when the temperature measurement result reaches a predetermined temperature threshold, waking up the electronic device and turning on the screen of the electronic device; otherwise, preventing the screen of the electronic device from being turned on.

4. The method of claim 1, wherein the step of selectively waking up the electronic device, not waking up the electronic device, controlling the screen of the electronic device to remain on, or turning off the screen of the electronic device further comprises:
based on the at least one thermal detection result and at least one G-sensor detection result obtained from at least one G-sensor of the electronic device, selectively waking up the electronic device, not waking up the electronic device, controlling the screen of the electronic device to remain on, or turning off the screen of the electronic device.

5. The method of claim 4, wherein the at least one thermal detection result comprises a temperature measurement result; and the step of selectively waking up the electronic device, not waking up the electronic device, controlling the screen of the electronic device to remain on, or turning off the screen of the electronic device further comprises:
when the temperature measurement result reaches a predetermined temperature threshold and the at least one G-sensor detection result matches a predetermined rule, waking up the electronic device or controlling the screen of the electronic device to remain on.

6. The method of claim 4, wherein the step of selectively waking up the electronic device, not waking up the electronic device, controlling the screen of the electronic device to remain on, or turning off the screen of the electronic device further comprises:
when the temperature measurement result reaches the predetermined temperature threshold and the at least one G-sensor detection result matches the predetermined rule, waking up the electronic device and turning on the screen of the electronic device; otherwise, preventing the screen of the electronic device from being turned on.

7. The method of claim 1, wherein the step of selectively waking up the electronic device, not waking up the electronic device, controlling the screen of the electronic device to remain on, or turning off the screen of the electronic device further comprises:
waking up the electronic device and turning on the screen of the electronic device;
wherein the method further comprises:
preventing the screen from displaying a slide-unlock-related hint, to allow a user of the electronic device to use the electronic device without slide-unlocking the electronic device.

8. The method of claim 1, wherein the step of selectively waking up the electronic device, not waking up the electronic device, controlling the screen of the electronic device to remain on, or turning off the screen of the electronic device further comprises:
waking up the electronic device and turning on the screen of the electronic device;
wherein the method further comprises:
controlling the screen to display an unlock-related hint, to allow a user of the electronic device to try unlocking the electronic device.

9. The method of claim 1, wherein the at least one thermal detection result comprises at least one temperature measurement result; and the method further comprises:
detecting whether the at least one temperature measurement result matches a predetermined temperature pattern; and
when it is detected that the at least one temperature measurement result matches the predetermined temperature pattern, unlocking the electronic device.

10. A computer program product, having program instructions for instructing a processing circuit of an electronic device to perform a method comprising the steps of:
detecting whether one or more temperature measurement results within at least one thermal detection result obtained from at least one thermal sensor of the electronic device match a predetermined temperature pattern; and
when it is detected that the one or more temperature measurement results match the predetermined temperature pattern, unlocking the electronic device.

11. An apparatus for controlling an electronic device with aid of thermal detection, the apparatus comprising at least one portion of the electronic device, the apparatus comprising:
at least one thermal sensor, capable of performing thermal detection for the electronic device, to generate at least one thermal detection result; and
a processing circuit, coupled to the at least one thermal sensor, capable of, based on the at least one thermal detection result, selectively waking up the electronic device, not waking up the electronic device, controlling a screen of the electronic device to remain on, or turning off the screen of the electronic device.

12. The apparatus of claim 11, wherein the at least one thermal detection result comprises a temperature measurement result; and when the temperature measurement result reaches a predetermined temperature threshold, the processing circuit wakes up the electronic device or controls the screen of the electronic device to remain on.

13. The apparatus of claim 11, wherein when the temperature measurement result reaches the predetermined temperature threshold, the processing circuit wakes up the electronic device and turns on the screen of the electronic device; otherwise, the processing circuit prevents the screen of the electronic device from being turned on.

14. The apparatus of claim 11, wherein based on the at least one thermal detection result and at least one G-sensor detection result obtained from at least one G-sensor of the electronic device, the processing circuit selectively wakes up the electronic device, not wakes up the electronic device, controls the screen of the electronic device to remain on, or turns off the screen of the electronic device.

15. The apparatus of claim 14, wherein the at least one thermal detection result comprises a temperature measurement result; and when the temperature measurement result reaches a predetermined temperature threshold and the at least one G-sensor detection result matches a predetermined rule, the processing circuit wakes up the electronic device or controls the screen of the electronic device to remain on.

16. The apparatus of claim 14, wherein when the temperature measurement result reaches the predetermined temperature threshold and the at least one G-sensor detection result matches the predetermined rule, the processing circuit wakes up the electronic device and turns on the screen of the electronic device; otherwise, the processing circuit prevents the screen of the electronic device from being turned on.

17. The apparatus of claim 11, wherein the processing circuit wakes up the electronic device and turns on the screen of the electronic device; and the processing circuit prevents the screen from displaying a slide-unlock-related hint, to allow a user of the electronic device to use the electronic device without slide-unlocking the electronic device.

18. The apparatus of claim 11, wherein the processing circuit wakes up the electronic device and turns on the screen of the electronic device; and the processing circuit controls the screen to display an unlock-related hint, to allow a user of the electronic device to try unlocking the electronic device.

19. The apparatus of claim 11, wherein the at least one thermal detection result comprises at least one temperature measurement result; the processing circuit detects whether the at least one temperature measurement result matches a predetermined temperature pattern; and when it is detected that the at least one temperature measurement result matches the predetermined temperature pattern, the processing circuit unlocks the electronic device.

20. The apparatus of claim 11, wherein the at least one thermal detection result comprises a plurality of temperature measurement results; the processing circuit detects whether the plurality of temperature measurement results matches a predetermined temperature pattern; and when it is detected that the plurality of temperature measurement results matches the predetermined temperature pattern, the processing circuit wakes up the electronic device.
